(19) United States
(12) Patent Application Publication
(10) Pub. No.: US 2004/0081895 A1
(43) Pub. Date: Apr. 29, 2004

(54) Battery

(76) Inventors: Momoe Adachi, Tokyo (JP); Shigeru Fujita, Tokyo (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/616,716

(22) Filed: Jul. 10, 2003

(30) Foreign Application Priority Data
Jul. 10, 2002 (JP) JP2002-201686

(51) Int. Cl. H01M 10/36; H01M 4/58

(52) U.S. Cl. 429/344; 429/345; 429/231.95

(57) ABSTRACT

The invention provides a battery with improved battery characteristics such as cycle characteristic and storage characteristic. The battery has a rolled electrode body by rolling a cathode and an anode sandwiching a separator in between. The capacity of the anode is expressed by the sum of a capacity component obtained by insertion and extraction of lithium and a capacity component obtained by deposition and dissolution of lithium. The separator is impregnated with an electrolyte solution obtained by dissolving a lithium salt in a solvent. A compound having a B—O bond or P—O bond such as lithium bis [1,2-benzenediolato (2-)-O,O′]borate or lithium tris [1,2-benzenediolato (2-)-O,O′]phosphate is used as a lithium salt. Thus, the formation of a stable film can suppress the decomposition reaction of the solvent and can also prevent the reaction of a deposited lithium metal with the solvent.

### BACKGROUND OF THE INVENTION

1. Field of the Invention

The present invention relates to a battery having a cathode, an anode, and an electrolyte and, more particularly, to a battery in which the capacity of the anode includes a capacity component obtained by insertion and extraction of a light metal and a capacity component obtained by deposition and dissolution of the light metal and is expressed by their sum.

2. Description of the Related Art

In recent years, the downsizing and lightweight of a portable electronic device typified by a portable telephone, PDA (Personal Digital Assistant) terminal device, or a notebook-sized computer have been vigorously implemented. Consequently, as part of it, improvement in energy density of a battery, particularly, a secondary battery as a driving source of the device has been strongly demanded.

An example of the secondary battery realizing a high energy density is a lithium ion secondary battery having an anode made of a material such as a carbon material capable of inserting and extracting lithium (Li). Since the lithium ion secondary battery is designed so that lithium inserted in the anode material always stays in an ion state, the energy density largely depends on the number of lithium ions that can be inserted in the anode material. It can be therefore considered that by increasing the inserted amount of lithium ions, the energy density of the lithium ion secondary battery can be further improved. However, the amount of lithium inserted into graphite that is believed to be a material capable of inserting and extracting lithium ions most efficiently at present is theoretically limited to 372 mAh in electric amount conversion per gram. Recently, by vigorous development activities, the amount of lithium inserted into graphite has been almost increased to the limit value.

Another secondary battery realizing high energy density is a lithium secondary battery having an anode made of a lithium metal and using only deposition and dissolution reaction of the lithium metal as a reaction of the anode. A lithium secondary battery is expected to achieve energy density higher than that of a lithium ion secondary battery since a theoretical electrochemical equivalent of a lithium metal in the lithium secondary battery is as large as 2,054 mAh/cm³ that is 2.5 times as large as that of graphite used for the lithium ion secondary battery. Hitherto, many researchers and the like have studied and developed to realize commercialization of lithium secondary batteries (for example, “Lithium Batteries”, edited by Jean-Paul Gabano, Academic Press, 1983, London, New York).

However, the lithium secondary battery has a problem such that the discharge capacity deteriorates largely when charge and discharge is repeated and it is consequently difficult to realize commercialization of the lithium secondary battery. The deterioration in capacity occurs due to the fact that the lithium secondary battery uses the deposition/dissolution reaction of a lithium metal in the anode. Since the volume of the anode largely increases/decreases only by the capacity in correspondence with lithium ions migrating between the cathode and anodes in association with charge and discharge, the volume of the anode largely fluctuates and it suppresses reversible dissolution reaction and recrystallization reaction of a lithium metal crystal. Moreover, the higher the energy density is desired to be realized, the more the volume of the anode changes and the deterioration in capacity becomes conspicuous.

The inventors herein therefore have newly developed a secondary battery in which the capacity of the anode includes a capacity component obtained by insertion and extraction of lithium and a capacity component obtained by deposition and dissolution of lithium and is expressed by their sum (refer to International Publication WO 01/22519 A1). Specifically, the anode is made of a carbon material capable of inserting and extracting lithium and the lithium is allowed to be deposited on the surface of the carbon material during charging. This secondary battery can be expected to have an improved charge/discharge cycle characteristic while achieving high energy density.

To commercialize the secondary battery, however, characteristics of the secondary battery have to be further improved and stabilized and it is absolutely necessary to study and develop not only the material of the electrode but also electrolytes. Particularly, there was a problem that the charge/discharge cycle characteristics, storage characteristic or the like were liable to deteriorate due to the decomposition reaction of an electrolyte on the surface of the anode, the reaction of the deposited lithium metal with the electrolyte or the like.

The invention has been achieved in consideration of the problems and its object is to provide a battery with improved battery characteristics such as battery capacity, cycle characteristics and storage characteristic.

### SUMMARY OF THE INVENTION

The battery according to the invention comprises a cathode, an anode and an electrolyte, wherein the capacity of the anode includes a capacity component obtained by insertion and extraction of a light metal and a capacity component obtained by deposition and dissolution of the light metal and is expressed by their sum, and the electrolyte contains a light metal salt having a M-O bond (however, M represents any of boron (B), phosphorus (P), aluminum (Al), gallium (Ga), indium (In), thallium (Tl), arsenic (As), antimony (Sb) or bismuth (Bi)).

In the battery according to the invention, the electrolyte contains a light metal salt having a M-O bond, for example. Consequently, the decomposition reaction of the electrolyte is suppressed and the reaction of the light metal deposited in the deposition/dissolution reaction of the light metal with the electrolyte is prevented. The deposition/dissolution efficiency of the light metal in the anode is also improved. Thus, the battery characteristics such as the cycle characteristics and storage characteristic are improved.

### BRIEF DESCRIPTON OF THE DRAWINGS

FIG. 1 is a cross section showing the configuration of a secondary battery according to an embodiment of the invention.

FIG. 2 is a cross section enlargedly showing a part of a rolled electrode body in the secondary battery illustrated in FIG. 1.

### DETAILED DESCRIPTION OF THE PREFERRED EMBODIMENTS

Below described in detail is an embodiment of the invention referring to drawings.

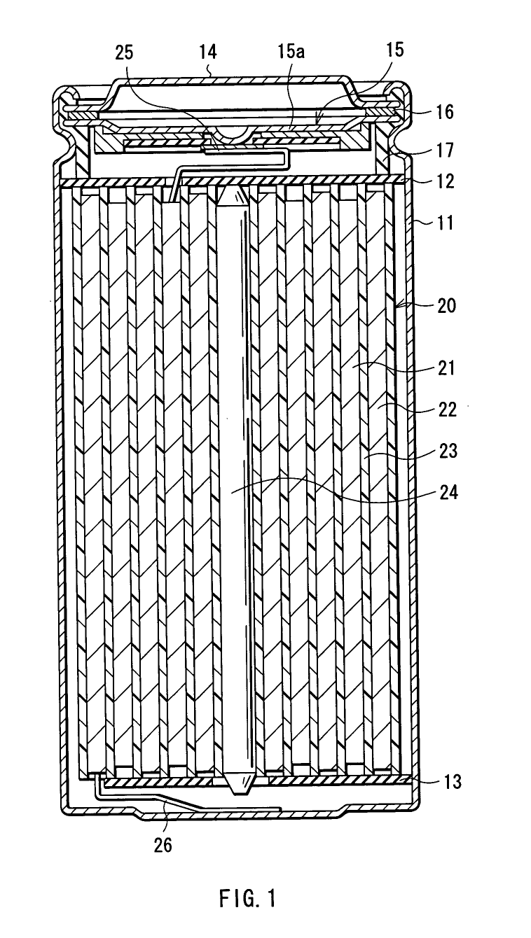

FIG. 1 is a cross section showing the configuration of a secondary battery according to an embodiment of the invention. The secondary battery is what is called of a cylindrical type. In a battery can 11 having a substantially hollow cylindrical column shape, a rolled electrode body 20 obtained by rolling a strip-shaped cathode 21 and an anode 22 sandwiching a separator 23 in between is provided. The battery can 11 is made of, for example, iron (Fe) plated with nickel (Ni). One end of the battery can 11 is closed and the other end thereof is open. In the battery can 11, a pair of insulating plates 12 and 13 is disposed perpendicular to the peripheral face of the roll so as to sandwich the rolled electrode body 20.

A battery cover 14, and a safety valve mechanism 15 and a positive temperature coefficient (PTC) device 16 which are provided on the inside of the battery cover 14 are attached to the open end of the battery can 11 by being caulked via a gasket 17 and the battery can 11 is sealed. The battery cover 14 is made of, for example, a material similar to that of the battery can 11. The safety valve mechanism 15 is electrically connected to the battery cover 14 via the PTC device 16. When the internal pressure of the battery increases to a predetermined value or higher due to internal short circuit, heating from the outside or the like, a disk plate 16a is turned upside down, thereby disconnecting the electrical connection between the battery cover 14 and the rolled electrode body 20. The PTC device 16 is used to limit current by increase in a resistance value when the temperature rises to prevent abnormal heating caused by heavy current. The PTC device 16 is made of, for example barium-titanate-based semiconductor ceramics. The gasket 17 is made of, for instance, an insulating material. Asphalt is applied on the surface of the gasket 17.

The rolled electrode body 20 is rolled around, for example, a center pin 24 as a center. A cathode lead 25 made of aluminum (Al) or the like is connected to the cathode 21 of the rolled electrode body 20, and an anode lead 26 made of nickel or the like is connected to the anode 22. The cathode lead 25 is welded to the safety valve mechanism 15, thereby being connected to the battery cover 14. The anode lead 26 is welded and electrically connected to the battery can 11.

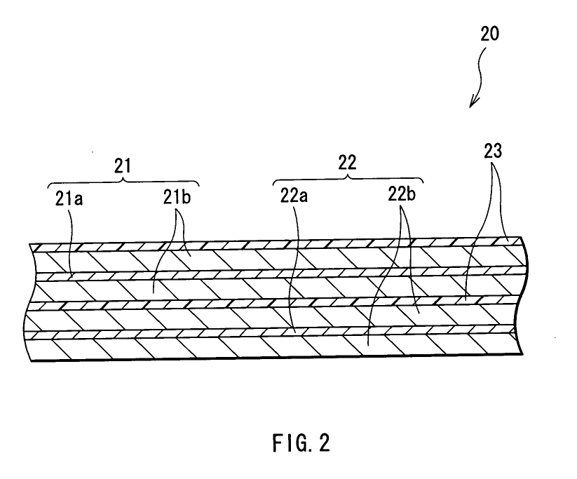

FIG. 2 enlargedly shows a part of the rolled electrode body 20 illustrated in FIG. 1. The cathode 21 has, for example, a structure in which a cathode mixture layer 21b is provided on both faces of a cathode collector 21a having a pair of opposite faces. Although not illustrated, the cathode mixture layer 21b may be provided on only one of the faces of the cathode collector 21a. The cathode collector 21a has a thickness of, for example, 5 μm to 50 μm and is made of metal foil such as aluminum foil, nickel foil, or stainless steel foil. The cathode mixture layer 21b has a thickness of, for example, 60 μm to 250 μm and contains a cathode material capable of inserting and extracting lithium as a light metal. When the cathode mixture layer 21b is provided on both faces of the cathode collector 21a, the thickness of the cathode mixture layer 21b is the total thickness.

Examples of cathode materials capable of inserting and extracting lithium are lithium-contained compounds such as a lithium oxide, a lithium sulfide, and an interlayer compound containing lithium. A mixture of two kinds or more of lithium-contained compounds may be also used. Particularly, to increase energy density, a lithium composite oxide expressed by a general formula of Li_{z}MO₂ or an interlayer compound containing lithium is preferable. Preferably, M denotes one kind or more of transition metals, and concretely, it is preferable to use at least one kind out of cobalt (Co), nickel (Ni), manganese (Mn), iron, aluminum, vanadium (V), and titanium (Ti). The small letter z varies with the charge/discharge state of a battery and is usually a value in the range of 0.05≦z≦1.10. It is also preferable to use LiMn₂O₄ having a spinel crystal structure or LiFePO₄ having an olivine crystal structure in order to obtain high energy density.

Such a cathode material is prepared by mixing, for example, a carbonate, nitrate, oxide, or hydroxide of lithium with a carbonate, nitrate, oxide, or hydroxide of a transition metal so as to have a desired composition, grinding the mixture, and after that, firing the resultant in an oxygen atmosphere at a temperature in a range from 600° C. to 1,000° C.

The cathode mixture layer 21b contains, for example, a conductive agent and, as necessary, may also contain a binder. Examples of the conductive agent are carbon materials such as graphite, carbon black and ketjen black. One of the materials or a mixture of two or more of the materials is used. Besides the carbon materials, a metal material, a conductive polymer, or the like can be also used as long as the material has conductivity. Examples of the binder are synthetic rubbers such as styrene-butadiene rubbers, fluororubbers, and ethylene propylene diene rubbers, and polymeric materials such as polyvinylidene fluoride. One of the materials or a mixture of two or more of them is used. For example, when the cathode 21 and the anode 22 are wound as shown in FIG. 1, it is preferable to use styrene-butadiene rubber or fluororubber as a binder, which have excellent flexibility.

The anode 22 has, for example, a structure in which an anode mixture layer 22b is provided on both faces of an anode collector 22a having a pair of opposite faces. Although not shown, the anode mixture layer 22b may be provided only on one face of the anode collector 22a. The anode collector 22a is made of, for instance, metal foil such as copper foil, nickel foil, or stainless foil having excellent electrochemical stability, electric conductivity and mechanical strength. Particularly, the copper foil is the most preferable since it has high electric conductivity. The thickness of the anode collector 22a is preferably, for example, about 5 μm to 40 μm. If the thickness is less than 5 μm, the mechanical strength is insufficient, the anode collector 22a is easily torn in a manufacturing process, and production efficiency deteriorates. If the thickness is more than 40 μm, the volume ratio of the anode collector 22a in the battery is larger than required, and it is difficult to increase energy density.

The anode mixture layer 22b is made to contain one kind or two kinds or more of anode materials capable of inserting and extracting lithium as a light metal and may contain, for example, a binder similar to that in the cathode mixture layer 21b, if required. The thickness of the anode mixture layer 22b is, for example, 40 μm to 250 μm. When the anode mixture layer 22b is provided on both faces of the anode collector 22a, the thickness is the total thickness.

Insertion and extraction of a light metal described in the specification denotes that ions of the light metal are electrochemically inserted and extracted without losing ionicity. It includes not only a case where an inserted light metal exists in a perfect ion state but also a case where the inserted light metal exists in an imperfect ion state. As examples of such cases, insertion by an electrochemical intercalation reaction of ions of a light metal with graphite can be mentioned. Further, the insertion of the light metal into an alloy containing an intermetallic compound or the insertion of a light metal by forming an alloy can be also mentioned.

As anode materials capable of inserting and extracting lithium, for example, carbon materials such as graphite, non-graphitizable carbon, and graphitizable carbon can be mentioned. These carbon materials are preferable since a change in a crystal structure that occurs at the time of charge/discharge is very small, and a large charge/discharge capacity and excellent charge/discharge cycle characteristic can be obtained. Particularly, graphite is preferable since an electrochemical equivalent is large and a high energy density can be obtained.

Graphite having, for example, true density of 2.10 g/cm³ or more is preferable, and graphite having true density of 2.18 g/cm³ or more is more preferable. To obtain such a true density, the thickness of a C-axis crystallite of the (002) plane has to be 14.0 nm or more. The spacing between (002) planes is preferably less than 0.340 nm, and more preferable is that the spacing is in a range from 0.335 nm to 0.337 nm both inclusive.

The graphite may be natural graphite or artificial graphite. The artificial graphite is obtained by, for example, carbonizing an organic material, performing high-temperature heat treatment, and grinding and classifying the material. The high-temperature heat treatment is performed by, for example, as necessary, carbonizing the material in an inert gas air current of nitrogen (N₂) or the like at 300° C. to 700° C., raising the temperature to 900° C. to 1500° C. at a rate of 1° C. to 100° C. per minute, temporarily calcining the material while keeping the temperature for about 0 to 30 hours, increasing the temperature to 2,000° C. or higher, preferably, 2,500° C. or higher and maintaining the temperature for a certain hours.

As an organic material that is a starting material, coal or pitch can be used. Examples of the pitch are pitches obtained by performing distillation (vacuum distillation, atmospheric distillation, or steam distillation), thermal polycondensation, extraction, and chemical polycondensation on tars, asphalt, or the like obtained by cracking coal tar, ethylene bottom oil, crude oil, or the like at a high temperature, pitches generated by performing dry distillation on woods, polyvinyl chloride resin, polyvinyl acetate, polyvinyl butyrate, and 3,5-dimethyl phenol resin. Each of the coals and pitches exists as liquid at the maximum temperature of about 400° C. in the middle of carbonization and is held at that temperature, thereby allowing aromatic rings to be condensed and polycyclic to achieve a stacked oriented state. After that, at a temperature of about 500° C. or higher, a solid carbon precursor, that is, semi-coke is obtained (liquid phase carbonization process).

As organic materials, condensed polycyclic carbonized hydrides such as naphthalene, phenanthrene, anthracene, triphenylene, pyrene, perylene, pentapherene, and pentacen, their derivatives (for example, carboxylic acid, carboxylic acid anhydride, and carboxylic acid imide), and mixtures of them can be used. Further, condensed heterocyclic compounds such as acenaphthylene, indole, isoindole, quinoline, isoquinoline, quinoxaline, phthalazine, carbazole, acridine, phenazine, and phenanthridine, their derivatives, and mixtures can be also used.

Grinding may be performed either before and after carbonization and calcination or during the temperature rising process before graphitization. In either case, finally, heat treatment for graphitization is performed on the material in a powder state. However, in order to obtain graphite powders of high bulk density and breaking strength, it is preferable to mold the material, perform heat treatment and grind and classify an obtained graphitized body.

For example, in the case of fabricating a graphitized body, cokes serving as fillers and a binder pitch serving as a molding agent or sintering agent are mixed and molded. After that, a firing process of performing heat treatment on the molded body at a low temperature of 1,000° C. or lower and a pitch impregnating process of impregnating the fired body with a fused binder pitch are repeated a few times, and the resultant is subjected to heat treatment at a high temperature. The impregnated binder pitch is carbonized by the aforementioned heat treatment process and graphitized. Since the fillers (chokes) and the binder pitch are used as materials in this case, a polycrystalline substance is obtained by graphitization and sulfur and nitrogen contained in the materials are generated as gas at the time of heat treatment, so that pores are formed in the path of the gas. There are advantages that the pores facilitate the progress of insertion and extraction reactions of lithium and the industrial processing efficiency is high. As the material of the molded body, the filler having moldability and sinterability in itself may be used. In this case, the process dispenses with a binder pitch.

Preferable non-graphitizable carbon is such that spacing between (002) planes is 0.37 nm or more, true density is lower than 1.70 g/cm³, and a heat generation peak does not appear at 700° C. or higher in differential thermal analysis (DTA) in the air.

Such a non-graphitizable carbon is obtained by, for example, performing heat treatment on an organic material at about 1,200° C. and grinding and classifying the resultant. The heat treatment is carried out by, for example, carbonizing the material at 300° C. to 700° C. (solid phase carbonizing process) as necessary, increasing the temperature to 900° C. to 1,300° C. at a rate of 1° C. to 100° C. per minute, and keeping the temperature for about 0 to 30 hours. The grinding may be performed before or after carbonization or during the temperature increasing process.

As an organic material as a starting material, for example, a polymer or copolymer of furfuryl alcohol or furfuryl, or a furan resin that is a copolymer of the high polymers with other resins can be used. A phenol resin, acrylic resin, halogenated vinyl resin, polyimide resin, polyamideimide resin, polyamide resin, a conjugated resin of polyacetylene, polyparaphenyn, or the like, cellulose or its derivatives, coffee beans, bamboos, crustacea including chitosan, or biocellulose using bacteria can be also used. Further, a compound obtained by introduction (oxygen cross-link) of a functional group containing oxygen (O) into petroleum pitch of which atomicity ratio H/C between hydrogen atoms (H) and carbon atoms (C) is, for example, 0.6 to 0.8 can be also used.

The content of oxygen in the compound is preferably 3% or higher and, more preferable is 5% or higher (refer to Japanese Patent Laid-open No. Hei 3-252053). The content of oxygen exerts an influence on the crystal structure of a carbon material, the physical properties of the non-graphitizable carbon can be improved at the above-mentioned content or higher, and the capacity of the anode 22 can be increased. In this regard, the petroleum pitch can be obtained by performing distillation (vacuum distillation, atmospheric distillation, or steam distillation), thermal polycondensation, extraction, or chemical polycondensation on tars obtained by cracking coal tar, ethylene bottom oil, crude oil, or the like, asphalt or the like at a high temperature. In addition, as an oxygen cross-link forming method, for example, a wet method of allowing a solution of nitric acid, sulfuric acid, hypochlorous acid or a mixed acid thereof to react with a petroleum pitch, a dry method of allowing oxidation gas such as the air or oxygen to react with the petroleum pitch, or a method of allowing solid reagents such as sulfur, ammonia nitrate, ammonia persulfate, or ferric chloride to react with the petroleum pitch can be used.

In addition, the organic materials as starting materials are not limited to the above-described materials. Other organic materials can be used as long as they can become a non-graphitizable carbon by solid-phase carbonizing process such as oxygen cross-link process.

Besides the non-graphitizable carbon manufactured by using the above-described organic materials as a starting material, a compound containing, as main components, phosphorus (P), oxygen, and carbon disclosed in Japanese Patent Laid-open No. Hei 3-137010 is also preferable since it exhibits the above-described physical parameters.

As anode materials capable of inserting and extracting lithium, an element, alloy, or compound of a metal element or a metalloid that can form an alloy with lithium can be mentioned. Those materials are preferable since they can obtain high energy density. Particularly, it is more preferable to use any of the materials together with a carbon material since high energy density and excellent charge/discharge cycle characteristic can be obtained. In the specification, alloys include an alloy consisting of one kind or more of metal element and one kind or more of metalloid, besides an alloy consisting of two kinds or more of metal elements. In the structure of each of the materials, solid solution, eutectic (eutectic mixture), or intermetallic compound exists or two kinds or more out of them exist.

Taken up as the examples of such metal elements or metalloid are tin (Sn), lead (Pb), aluminum, indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). Taken up as the alloys or compounds of the elements are the ones expressed by, for example, a chemical formula of MaₛMbₜLiᵤ or MaₚMc_{q}Mdᵣ. In the chemical formulas, Ma represents at least one kind out of metal element and metalloid capable of forming an alloy with lithium, Mb denotes at least one kind out of metal elements and metalloids other than lithium and Ma, Mc represent at least one kind of non-metallic elements, and Md represents at least one kind out of metal elements and metalloids other than Ma. The values of s, t, u, p, q, and r satisfy s>0, t≧0, u≧0, p>0, q>0, and r≧0, respectively.

Specially, an element, alloy, or compound of a group 4B metal element or metalloid is preferable. Particularly preferable elements are silicon or tin, and their alloys or compounds, which may be crystalline or amorphous ones.

Concrete examples of the alloys and compounds are LiAl, AlSb, CuMgSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≧2), SnO_{w} (0<w≧2), SnSiO₃, LiSiO, LiSnO and the like.

Examples of anode materials capable of inserting and extracting lithium are other metal compounds and polymeric materials. The other metal compounds include oxides such as iron oxide, ruthenium oxide, and molybdenum oxide, LiN₃ and the like. The polymeric materials include polyacetylene, polyaniline, and polypyrrole, and the like.

Moreover, in the secondary battery, the lithium metal is designed to start precipitating on the anode 22 at a time when an open circuit voltage (that is, battery voltage) is lower than overcharge voltage in a charging process. Specifically, in a state where the open circuit voltage is lower than the overcharge voltage, the lithium metal is deposited on the anode 22 and the capacity of the anode 22 includes a capacity component obtained by insertion and extraction of lithium and a capacity component obtained by deposition and dissolution of the lithium metal and is expressed by their sum. In the secondary battery, therefore, both the anode material capable of inserting/extracting lithium and the lithium metal function as anode activated materials, and the anode material capable of inserting and extracting lithium serves as a base material at the time of deposition of the lithium metal.

In addition, the overcharge voltage indicates an open circuit voltage when a battery is placed in an overcharged state and, for example, a voltage higher than the open circuit voltage of the battery which is “completely charged” described and defined in “safety evaluation reference guideline of lithium secondary batteries” (SBA G1101) as one of the guidelines determined by Battery Association of Japan. In other words, the overcharge voltage is a voltage higher than an open circuit voltage obtained after charging is performed according to a charging method used for obtaining the nominal capacity of a battery, a standard charging method, or a recommended charging method. Concretely, for example, when an open circuit voltage is 4.2 V, the secondary battery is completely charged. In a part of the range from 0 V to 4.2 V both inclusive of the open circuit voltage, a lithium metal is deposited on the surface of the anode material capable of inserting/extracting lithium.

Therefore, the secondary battery can obtain high energy density and improved cycle characteristic and quick charge/discharge characteristic. Although the secondary battery is similar to the conventional lithium secondary battery using a lithium metal or lithium alloy for the anode from the point that the lithium metal is deposited on the anode 22, it is considered that the following advantages result from the process as above-mentioned by allowing the lithium metal to be deposited on the anode material capable of inserting/extracting lithium.

Firstly, in a conventional lithium secondary battery, it is difficult to allow the lithium metal to be deposited uniformly, and it causes deterioration in the cycle characteristic. However, since the surface area of the anode material capable of inserting/extracting lithium is generally large, the lithium metal can be uniformly deposited in this secondary battery. Secondly, in the conventional lithium secondary battery, a volume changes largely in association with the deposition and extraction of the lithium metal and it also causes deterioration in the cycle characteristic. On the contrary, in this secondary battery, since the lithium metal is also deposited in the gaps between the particles of the anode material capable of inserting/extracting lithium, the volume changes little. Thirdly, in the conventional lithium secondary battery, the larger the deposition/dissolution amount of the lithium metal is, the more serious the above-mentioned problem becomes. In this secondary battery, however, the insertion and extraction of lithium by the anode material capable of inserting/extracting lithium also contribute to the charge/discharge capacity. Consequently, although the battery capacity is large, the deposition/dissolution amount of the lithium metal is small. Fourthly, in the conventional lithium secondary battery, when quick charging is performed, since the lithium metal is deposited more ununiformly, the cycle characteristic further deteriorates. In this secondary battery, however, since the lithium is inserted in the anode material capable of inserting/extracting the lithium in the beginning of charging, quick charging can be performed.

To obtain these advantages more effectively, for example, when the open circuit voltage is the maximum voltage before it reaches an overcharge voltage, the maximum deposition amount of the lithium metal deposited on the anode 22 is preferably 0.05 to 3.0 times as large as the charging capacity of the anode material capable of inserting/extracting lithium. If the amount of deposition of the lithium metal is too large, problems similar to those of the conventional lithium secondary battery occur. If it is too small, a sufficiently large charge/discharge capacity cannot be achieved. For example, the discharge capacity of the anode material capable of inserting/extracting lithium is preferably 150 mAh/g or larger. This is because the larger the inserting/extracting capacity of lithium is, the deposition amount of the lithium metal is relatively smaller. The charge capacity of the anode material can be obtained from, for example, quantity of electricity at the time of charging the anode made of an anode active material to 0 V according to a constant current and constant voltage method when the lithium metal is used for an antipole. The discharging capacity of the anode material is obtained from, for example, quantity of electricity at the time of discharging the anode to 2.5 V for 10 hours or longer by a constant current method.

The separator 23 is formed of, for example, a porous film made of synthetic resin such as polytetrafluoroethylene, polypropylene, or polyethylene or a porous film made of ceramics. The separator 23 may have a structure in which two kinds or more of porous films are laminated. Particularly, a porous film made of polyolefine is preferable since it is excellent in short-circuiting preventing effect and can realize improved safety of the battery by its shutdown effect. Particularly, since polyethylene can obtain the shutdown effect in the range from 100° C. to 160° C. both inclusive and also has electrochemical stability, it is preferable as the material of the separator 23. Polypropylene is also preferable. If any other resin has chemical stability, they can be used by copolymerization or blending with polyethylene or polypropylene.

The separator 23 is impregnated with an electrolyte solution, which is a liquid-state electrolyte. The electrolyte solution contains a nonaqueous solvent that is a liquid solvent such as, for example, organic solvent and an electrolyte salt dissolved in the nonaqueous solvent, and may contain various additives if required. The liquid nonaqueous solvent is made of, for example, a nonaqueous compound, whose intrinsic viscosity at 25° C. is 10.0 mPa·s or less. A nonaqueous component, whose intrinsic viscosity in a state where the electrolyte salt is dissolved is 10.0 mPa·s or less may be also used. If a plurality of kinds of nonaqueous compounds are mixed to form a solvent, it is sufficient that the intrinsic viscosity in the mixed state is 10.0 mPa·s or less.

As such a nonaqueous solvent, various nonaqueous solvents conventionally used can be employed. Concretely, cyclic ester carbonate such as propylene carbonate or ethylene carbonate, chain ester such as ester carbonate, diethyl carbonate, dimethyl carbonate, or ethylmethyl carbonate, ether such as γ-butyrolactone, sulfolane, 2-methyltetrahydrofuran, or dimethoxyethane can be mentioned. These may be singly used or a mixture of a plurality of kinds may be also used. Particularly, from the viewpoint of oxidation stability, it is preferable to contain ester carbonate in the nonaqueous solvent.

It is preferable to use at least one kind of lithium salts having a M-O bond (herein, M represents any one of boron, phosphorus, aluminum, gallium, indium, thallium, arsenic, antimony or bismuth). This is because it is considered that such lithium salts form a stable film on the surface of the anode 22 in the charge/discharge cycle, thereby enabling to suppress the decomposition reaction of the solvent and prevent the reaction of the lithium metal deposited on the anode 22 with the solvent.

Particularly, a lithium salt having a B—O bond or a P—O bond is preferable, and more preferable is a lithium salt having an O—B—O bond or an O—P—O bond. This is because these salts can obtain a higher effect. Examples of lithium salts are cyclic compounds such as lithium bis [1,2-benzenediolato (2-)-O,O′]borate shown in Chemical Formula 1 or lithium tris [1,2-benzenediolato (2-)-O,O′]phosphate shown in Chemical Formula 2 are preferably taken up. This is because it is considered that a cyclic portion of their compounds is also involved in the formation of the film, thereby enabling to obtain the stable film.

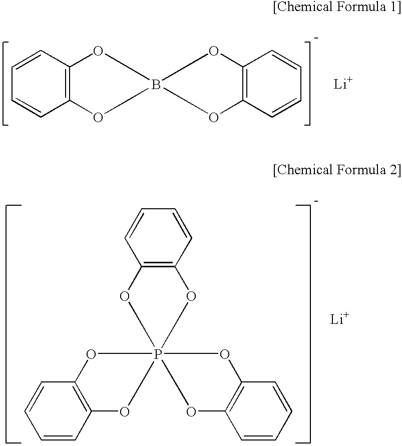

In addition the lithium salt having such the M-O bond, it is preferable to use other lithium salts mixed thereto. This is because battery characteristics such as storage characteristic and the like can be further improved. Examples of other lithium salts are for example LiAsF₆, LiPF₆, LiBF₄, LiClO₄, LiB(C₆H₅)₄, LiCH₃SO₃, LiCF₃SO₃, LiN(CF₃SO₂)₂, LiN(C₂F₅SO₂)₂, LiN(C₄F₉SO₂) (CF₃SO₂), LiC(CF₃SO₂)₃, LiAlCl₄, LiSiF₆, LiCl or LiBr. It may be used by mixing any one kind or two kinds or more of other lithium salts together.

Particularly, LiPF₆, LiBF₄, LiClO₄, LiN(CF₃SO₂)₂, LiN(C₂F₅SO₂)₂ and LiC(CF₃SO₂)₂ are preferable since they can have a higher effect and can obtain a high conductivity.

It is preferable that the content (concentration) of an electrolyte salt is within a range of 0.4 mol/l or more and 3.0 mol/l or less to a solvent. This is because a sufficient battery characteristic may not be probably obtained due to the extreme deterioration of ion conductivity in a range other than the above-mentioned range. Of the range, it is preferable that the content of a lithium salt having the M-O bond is within a range of 0.01 mol/l or more and 2.0 mol/l or less to the solvent. This is because a higher effect can be obtained within the range.

A gel electrolyte in which an electrolyte solution is held in a polymeric compound may be used in place of an electrode solution. The ion conductivity of the gel electrolyte may be 1 mS/cm or higher at a room temperature, and the composition and the structure of a polymeric compound are not particularly limited. The electrolyte solutions (that is, liquid-state solutions, electrolyte salts, and additives) are as described above. Examples of the polymeric compounds are polyacrylonitrile, polyvinylidene fluoride, a copolymer between polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitril-butadiene rubber, polystyrene or polycarbonate. Particularly, from the viewpoint of electrochemical stability, it is desirable that the polymeric compound having the structure of polyacrylonitrile, polyvinylidene fluoride, polyhexafluoropropylene or polyethylene oxide is used. It is preferable to usually add the electrolyte solution to an amount of the polymeric compound equivalent to 5 wt % to 50 wt % of the electrolyte solution although it varies with compatibility between the electrolyte solution and the polymeric compound.

In addition, the content of a lithium salt is the same as in an electrolyte solution. The concept of a solvent here widely includes not only a liquid-state solvent but also a solvent capable of dissociating electrolyte salt and having ion conductivity. Therefore, if a polymeric compound having ion conductivity is used, the high molecular compound is also considered as the solvent.

For example, the secondary battery can be manufactured as follows.

Firstly, for instance, a cathode mixture is prepared by mixing the cathode material capable of inserting and extracting lithium, a conductive agent and a binder. The cathode mixture is dispersed in a solvent of N-methyl-2-pyrrolidone or the like to obtain a cathode mixture slurry in a paste state. The cathode mixture slurry is applied over the cathode collector 21a, dried and compression molded by a roll presser or the like, thereby forming the cathode mixture layer 21b. The cathode 21 is thus fabricated.

Subsequently, for example, the anode material capable of inserting and extracting lithium and the binder are mixed to prepare an anode mixture. The anode mixture is dispersed in a solvent of N-methyl-2-pyrrolidone or the like to obtain an anode mixture slurry in a paste state. The anode mixture slurry is applied over the anode collector 22a, dried, and compression molded by a roll presser or the like, thereby forming the anode mixture layer 22b. The anode 22 is thus fabricated.

Subsequently, the cathode lead 25 is attached to the cathode collector 21a by welding or the like, and the anode lead 26 is attached to the anode collector 22a by welding or the like. After that, the cathode 21 and the anode 22 are rolled sandwiching the separator 23 in between, the tip of the cathode lead 25 is welded to the safety valve mechanism 15, the tip of the anode lead 26 is welded to the battery can 11, and the rolled cathode 21 and anode 22 are sandwiched by the pair of insulating plates 12 and 13 and enclosed in the battery can 11. After the cathode 21 and the anode 22 are enclosed in the battery can 11, the electrolyte is injected into the battery can 11 and the separator 23 is impregnated with the electrolyte. The battery cover 14, the safety valve mechanism 15, and the PTC device 16 are fixed to the open end of the battery can 11 via the gasket 17 by caulking. The secondary battery shown in FIG. 1 is thus formed.

The secondary battery acts as follows.

When the secondary battery is charged, lithium ions are extracted from the cathode mixture layer 21b and are first inserted in the anode material capable of inserting/extracting lithium contained in the anode mixture layer 22b via the electrolyte solution with which the separator 23 is impregnated. If charging is further continued, in a state where the open circuit voltage is lower than the overcharge voltage, the charge capacity exceeds the charge capacity of the anode material capable of inserting/extracting lithium, and the lithium starts to be deposited on the surface of the anode material. After that, until the charging is finished, the lithium metal continues to be deposited on the anode 22. If graphite is, for example, used as the anode material capable of inserting/extracting lithium, the appearance of the anode mixture layer 22b changes from black to gold and further to silver.

After that, when the secondary battery is discharged, first, the lithium metal deposited on the anode 22 is released as ions and inserted in the cathode mixture layer 21b via the electrolyte solution with which the separator 23 is impregnated. When discharging is continued, the lithium ions inserted in the anode material capable of inserting/extracting lithium in the anode mixture layer 22b are extracted and inserted in the cathode mixture layer 21b via the electrolyte. Therefore, the secondary battery can obtain the characteristics of both the so-called conventional lithium secondary battery and the lithium ion secondary battery, that is, high energy density and excellent charge/discharge cycle characteristic.

It is considered that particularly, in the embodiment of the invention, the stable film is formed on the surface of the anode 22 in the charge/discharge cycle, since the electrolyte contains the lithium salt having the M-O bond. The stable film suppresses the decomposition reaction of the solvent on the anode 22 and prevents the reaction of the lithium metal deposited on the anode 22 with the electrolyte. The deposition and dissolution efficiency of the lithium metal are thus improved.

As described above, in accordance with the embodiment, the electrolyte is allowed to contain the lithium salt having the M-O bond. Therefore, it is possible to suppress the decomposition of the solvent on the anode 22 and prevent the reaction of the lithium metal deposited on the anode 22 with the solvent. The deposition and dissolution efficiency of the lithium metal can be thus improved and the battery characteristics such as cycle characteristic can be also improved.

Particularly, the battery characteristics such as the storage characteristic can be improved if other lithium salts are allowed to be contained in addition to the lithium salt having the M-O bond.

### EXAMPLES

Further, described in detail are concrete examples of the invention referring to FIG. 1 and FIG. 2.

### Examples 1 to 6

An area density ratio between the cathode 21 and the anode 22 was adjusted and a battery in which the capacity of the anode 22 includes a capacity component obtained by insertion and extraction of lithium and a capacity component obtained by the deposition and dissolution of lithium and is expressed by their sum was fabricated.

First, lithium carbonate (Li₂CO₃) and cobalt carbonate (CoCO₃) were mixed at a molar ratio of (Li₂CO₃): (CoCO₃)=0.5:1. The mixture was fired at 900° C. for 5 hours in the air, thereby obtaining a lithium/cobalt composite oxide (LiCoO₂) as a cathode material. Subsequently, the lithium/cobalt composite oxide of 91 parts by mass, graphite of 6 parts by mass as a conductive agent, polyvinylidene fluoride of 3 parts by mass as a binder were mixed, thereby preparing a cathode mixture. After that, the cathode mixture was dispersed in N-methyl-2-pyrrolidone as a solvent, thereby obtaining the cathode mixture slurry. The cathode mixture slurry was uniformly applied over both faces of the cathode collector 21a made of aluminum foil in a strip shape having a thickness of 20 μm, dried, and compression molded by a roll presser, thereby forming the cathode mixture layer 21b and fabricating the cathode 21. After that, the cathode lead 25 made of aluminum was attached to one end of the cathode collector 21a.

In addition, artificial graphite powders were prepared as an anode material, and the artificial graphite powders of 90 parts by mass and polyvinylidene fluoride of 10 parts by mass as a binder were mixed, thereby preparing an anode mixture. The anode mixture was dispersed in N-methyl-2-prrrolidone as a solvent to obtain an anode mixture slurry. After that, the anode mixture slurry was uniformly applied over both faces of the anode collector 22a made of copper foil in a strip shape having a thickness of 15 μm, dried, compression molded by a roll presser, thereby forming the anode mixture layer 22b and fabricating the anode 22. After that, the anode lead 26 made of nickel was attached to one end of the anode collector 22a.

After fabricating the cathode 21 and the anode 22, the separator 23 made by a microporous polypropylene film having a thickness of 25 μm was prepared. The anode 22, the separator 23, the cathode 21, and the separator 23 were stacked in this order and the stacked body was rolled a number of times in a scroll shape to form the rolled electrode body 20.

After fabricating the rolled electrode body 20, the rolled electrode body 20 was sandwiched by a pair of insulating plates 12 and 13, the anode lead 26 was welded to the battery can 11, the cathode lead 25 was welded to the safety valve mechanism 15, and the rolled electrode body 20 was enclosed in the battery can 11 made of iron plated with nickel. After that, an electrolyte solution was injected into the battery can 11 by a decompression method. An electrolyte solution in which a lithium salt as an electrolyte salt was dissolved in a solvent in which ethylene carbonate of 50 vol % and diethyl carbonate of 50 vol % were mixed, was used.

In this case, the kinds and contents of the lithium salts were changed as shown in Table 1 in Examples 1 to 6. Of the Examples, Example 1 used lithium bis [1,2-benzenediolato (2-)-O,O′]borate shown in Chemical Formula 1. Examples 2 to 5 used a mixture of lithium bis [1,2-benzenediolato (2-)-O,O′]borate shown in Chemical Formula 1 with other lithium salts. Example 6 used lithium tris [1,2-benzenediolato (2-)-O,O′]phosphate shown in Chemical Formula 2. The content of the electrolyte salt was determined to be 0.5 mol/l in each of Examples 1 to 6.

TABLE 1

| | | | | Volume- | Volume- | |
|---|---|---|---|---|---|---|
| | Electrolyte salt | | Initial | retention rate | retention rate | Deposition |
| | | Content | capacity | of 100th cycle | after storage | of |
| | Kind | (mol/l) | (mAh) | (%) | (%) | Li metal |
| Example 1 | Lithium salt in | 0.5 | 1068 | 85.5 | 86.2 | Deposited |
| | Chemical Formula 1 | | | | | |
| Example 2 | Lithium salt in | 0.4 | 1070 | 87.8 | 91.5 | Deposited |
| | Chemical Formula 1 | | | | | |
| | LiPF₆ | 0.1 | | | | |
| Example 3 | Lithium salt in | 0.4 | 1065 | 86.4 | 88.2 | Deposited |
| | Chemical Formula 1 | | | | | |
| | LiBF₄ | 0.1 | | | | |
| Example 4 | Lithium salt in | 0.4 | 1068 | 87.5 | 90.1 | Deposited |
| | Chemical Formula 1 | | | | | |
| | LiN(CF₃SO₂)₂ | 0.1 | | | | |
| Example 5 | Lithium salt in | 0.4 | 1067 | 86.5 | 87.3 | Deposited |
| | Chemical Formula 1 | | | | | |
| | LiClO₄ | 0.1 | | | | |
| Example 6 | Lithium salt in | 0.5 | 1065 | 85.1 | 85.4 | Deposited |
| | Chemical Formula 2 | | | | | |
| Comparative | LiPF₆ | 0.5 | 1068 | 75.5 | 86.0 | Not- |
| Example 1 | | | | | | Deposited |
| Comparative | Lithium salt in | 0.4 | 905 | 89.2 | 85.0 | Not- |
| Example 2 | Chemical Formula 1 | | | | | Deposited |
| | LiPF₆ | 0.1 | | | | |
| Comparative | LiPF₆ | 0.5 | 907 | 91.5 | 86.1 | Not- |
| Example 3 | | | | | | Deposited |

The electrolyte solution was injected into the battery can 11 and the battery cover 14 was fixed to the battery can 11 by caulking via the gasket 17 to which asphalt was applied, thereby obtaining cylindrical secondary batteries having a diameter of 14 mm and a height of 65 mm of Examples 1 to 6.

In addition, as Comparative Example 1 to Examples, except that LiPF₆ was used as an electrolyte salt, a secondary battery was fabricated in a manner similar to Examples. Further, as comparative Examples 2 and 3 to Examples, the area density ratio between the cathode and the anode was adjusted, and lithium ion secondary batteries in which the capacity of the anode is expressed by insertion and extraction of lithium were fabricated. In this case, in Comparative Example 2, the lithium salt in Chemical Formula 1 and LiPF₆ were used as the electrolyte salts as in Examples 2, and in Comparative Example 3, LiPF₆ was used as the electrolyte salt.

The cycle characteristic and storage characteristic were each investigated on the obtained secondary batteries of Examples 1 to 6 and Comparative Examples 1 to 3. For the cycle characteristic, a charge/discharge test was conducted at a normal temperature to find the volume retention rate of 100th cycle (volume of 100th cycle/initial volume) to the initial volume (volume of 1st cycle)×100. In this case, after charging was performed until a battery voltage reached 4.2 V with a constant current of 600 mA, the charging was further performed until a battery current reached 1 mA with a constant voltage of 4.2 V. Discharging was performed until a battery voltage reached 3.0 V with a constant current of 400 mA. In this connection, if the charging/discharging is performed under the conditions shown above, a complete charged state and a complete discharged state are set. Table 1 shows the results.

Each of the secondary batteries of Examples 1 to 6 and Comparative Examples 1 to 3, which was charged and discharged in one cycle under the above-described conditions and completely charged again was decomposed. A check was made to see whether or not the lithium metal was deposited on the anode mixture layer 22b by visual inspection and ⁷Li nuclear magnetic resonance spectrome. Further, the charging/discharging was performed in two cycles under the above-described conditions. The completely discharged secondary battery was decomposed and a check was similarly made to see whether or not the lithium metal was deposited on the anode mixture layer 22b.

As a result, in the secondary batteries of Examples 1 to 6 and Comparative Example 1, the existence of the lithium metal was recognized in the anode mixture layer 22b in the completely charged state and the existence of the lithium metal was not recognized in the completely discharged state. That is, it was confirmed that the capacity of the anode 22 includes a capacity component obtained by deposition/dissolution of the lithium metal and a capacity component obtained by insertion/extraction of the lithium and is expressed by their sum. Table 1 described that the lithium metal was deposited as the result.

On the other hand, in the secondary batteries of Comparative Examples 2 and 3, the existence of the lithium metal was recognized in neither the completely charged state nor the completely discharged state but the existence of the lithium ion was merely recognized. The peak attributable to the lithium ion recognized in the completely discharged state was very small. That is, it was confirmed that the capacity of the anode is expressed by a capacity component obtained by insertion/extraction of the lithium. Table 1 described that the lithium metal was not deposited as the result.

In addition, for storage characteristic, the second cycle charging was performed on the secondary battery under the above-described conditions, after the secondary battery had been stored in the thermostatic bath at 60° C. for two weeks, discharging was performed under the above-described conditions to find the volume retention rate after storage to initial volume (volume after storage/initial volume)×100. Table 1 shows the results.

As is clear from Table 1, in accordance with Examples 1 to 6 using the lithium salts having the M-O bond, the volume retention rate of 100th cycle could be more heightened than that of Comparative Example 1 without the lithium salts having the M-O bond. On the contrary, in Comparative Examples 2 and 3 with the lithium ion secondary batteries, the cycle characteristic of Comparative Example 2 using the lithium salt having the M-O bond was lower than that of Comparative Example 3 without the lithium salts having the M-O bond.

In addition, in Examples 1 to 6 in which the capacity of the anode 22 includes a capacity component obtained by insertion/extraction of the light metal and a capacity component obtained by the deposition/dissolution of the light metal and is expressed by their sum, the first capacity was 1,060 mAh or higher while each of the first capacity in Comparative Examples 2 and 3 with the lithium ion secondary batteries was about 900 mAh.

Namely, in the secondary battery in which the capacity of the anode 22 includes a capacity component obtained by insertion/extraction of the light metal and a capacity component obtained by deposition/dissolution of the light metal and is expressed by their sum, a large capacity can be obtained and the charge/discharge cycle characteristic can be improved if the electrolyte is allowed to contain the lithium salt having the M-O bond.

Further, as is clear from a comparison between Examples 1 to 5, in accordance with Examples 2 to 5 using a mixture of the lithium salt in Chemical Formula 1 and other lithium salts, a volume retention rate after storage could be more heightened than that of Example 1 using only the lithium salt in Chemical Formula 1. Namely, it was found that the storage characteristic could be improved by further using other lithium salts as a mixture with the lithium salt having the M-O bond.

In addition, in the above-described Examples, the lithium salts having the M-O bond are described by taking up the concrete examples. It is considered that the above-described effects are attributable to the M-O bond. Therefore, similar effects can be obtained by using other lithium salts having the M-O bond. In addition, although the case of using an electrolytic solution has been described in the above-described Examples, similar results can be also obtained by using a gel electrolyte.

Although the invention has been described by the embodiment and examples, the invention is not limited to the embodiment and examples but can be variously modified. For example, although the case of using lithium as a light metal has been described in the forgoing embodiment and examples, the invention can be also applied to cases of using other alkali metals such as sodium (Na) and potassium (K), alkaline earth metals such as magnesium and calcium (Ca), other light metals such as aluminum, and alloys of lithium or those metals, and similar effects can be obtained. In this case, the anode material capable of inserting and extracting a light metal, cathode material, nonaqueous solvent, electrolyte salt, and the like are selected according to the light metal. Namely, although the lithium salts having the M-O bond have been used as the electrolyte salts in the above-described embodiment and examples, light metal salts having the M-O bond according to the light metal can be used.

However, if lithium or an alloy containing lithium is used as a light metal, it is preferable since voltage compatibility with a currently commercialized lithium ion secondary battery is high. In addition, if an alloy containing lithium is used as a light metal, a substance which can possibly form an alloy with lithium may exist in the electrolyte and an alloy may be formed at the time of deposition, and a substance which can possibly form an alloy with lithium on the anode and an alloy may be formed at the time of deposition.

Although the case of using an electrolyte solution or a gel electrolyte as a kind of a solid electrolyte has been described in the foregoing embodiment and examples, other electrolytes may be used. Examples of the other electrolytes are an organic solid electrolyte in which an electrolyte salt is dispersed in a polymeric compound having ion conductivity, an inorganic solid electrolyte made of ionic conductive ceramics, ionic conductive glass, ionic crystal, or the like, a mixture of any of the inorganic solid electrolytes and an electrolyte solution, and a mixture of any of the inorganic solid electrolytes and a gel electrolyte or an organic solid electrolyte.

Further, although the cylindrical secondary battery having the rolled structure has been described in the foregoing embodiment and examples, the invention can be also similarly applied to the secondary battery of an oval shape or a polygonal shape having the rolled structure, and a secondary battery having the structure in which a cathode and an anode are folded or stacked. In addition, the invention can be also applied to the secondary battery of a so-called coin type, button type, rectangular type, or the like. The invention is not limited to the secondary batteries but can be also applied to the primary batteries.

As described above, in accordance with the battery of the invention, since the electrolyte is allowed to contain light metal salts having the M-O bond, the decomposition reaction of the electrolyte on the anode can be suppressed and the reaction of the light metal deposited on the anode with the electrolyte can be prevented. Therefore, the deposition and dissolution efficiency of the light metal can be improved and the battery characteristics such as cycle characteristic can be also improved.

Particularly, in accordance with the battery of the invention, since the electrolyte is allowed to contain other light metal salts besides the light metal salts having the M-O bond, therefore the battery characteristics such as storage characteristic can be improved.

What is claimed is:

1. A battery comprising a cathode, an anode, and an electrolyte,
wherein the capacity of the anode includes a capacity component obtained by insertion and extraction of a light metal and a capacity component obtained by deposition and dissolution of the light metal and is expressed by their sum, and
the electrolyte contains a light metal salt having a M-O bond (herein, M represents any of boron (B), phosphorus (P), aluminum (Al), gallium (Ga), indium (In), thallium (Tl), arsenic (As), antimony (Sb) or bismuth (Bi)).

2. A battery according to claim 1, wherein the light metal has a B—O bond or a P—O bond.

3. A battery according to claim 1, wherein the light metal has an O—B—O bond or an O—P—O bond.

4. A battery according to claim 1, wherein the light metal is a cyclic compound.

5. A battery according to claim 1, wherein the light metal is lithium bis [1,2-benzenediolato (2-)-O,O′]borate shown in Chemical Formula 3 or lithium tris [1,2-benzenediolato (2-)-O,O′]phosphate shown in Chemical Formula 4.

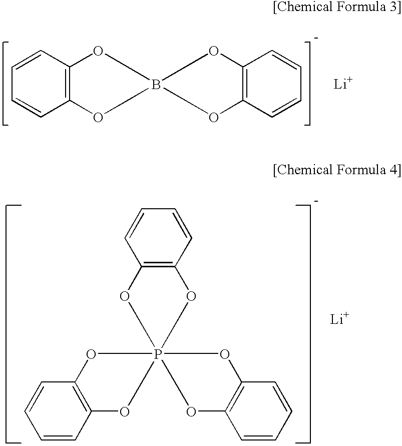

6. A battery according to claim 1, wherein the anode contains an anode material capable of inserting/extracting a light metal.

7. A battery according to claim 6, wherein the anode contains a carbon material.

8. A battery according to claim 7, wherein the anode contains at least one kind out of a group comprising graphite, a graphitizable carbon and a non-graphitizable carbon.

9. A battery according to claim 8, wherein the anode contains graphite.

10. A battery according to claim 6, wherein the anode contains at least one kind out of a group comprising an element, alloy or compound of a metal element or a metalloid which can form an alloy with the light metal.

11. A battery according to claim 10, wherein the anode contains at least one kind out of a group of an element, alloy or compound of tin (Sn), lead (Pb), aluminum, indium, silicon (Si), zinc (Zn), antimony, bismuth, cadmium (Cd), magnesium (Mg), boron, gallium, germanium (Ge), arsenic, silver (Ag), zirconium (Zr), yttrium (Y) or hafnium (Hf).

12. A battery according to claim 1, wherein the electrolyte contains a polymeric compound or an inorganic solid electrolyte.

13. A battery according to claim 1, wherein the electrolyte further contains LiPF₆.

14. A battery according to claim 1, wherein the electrolyte further contains LiPF₄.

15. A battery according to claim 1, wherein the electrolyte further contains LiN(CF₃SO₂)₂.

16. A battery according to claim 1, wherein the electrolyte further contains LiN(C₂F₅SO₂)₂.

17. A battery according to claim 1, wherein the electrolyte further contains LiC(CF₃SO₂)₃.

18. A battery according to claim 1, wherein the electrolyte further contains LiClO₄.
